(19) United States
(12) Patent Application Publication
(10) Pub. No.: US 2026/0246589 A1
(43) Pub. Date: Aug. 20, 2026

(54) METHODS TO SUPPORT FLEXIBLE CONFIGURATION OF EIGHT PORT SOUNDING REFERENCE SIGNAL AND RELATED SYSTEMS AND APPARATUSES

(71) Applicant: APPLE INC., Cupertino, CA (US)

(72) Inventors: Haitong Sun, Cupertino, CA (US); Jie Cui, San Jose, CA (US); Chunxuan Ye, San Diego, CA (US); Dawei Zhang, Saratoga, CA (US); Wei Zeng, San Diego, CA (US); Ankit Bhamri, Bad Nauheim (DE)

(21) Appl. No.: 19/165,269

(22) PCT Filed: Mar. 27, 2024
(86) PCT No.: PCT/US2024/021705

§ 371 Date: Sep. 15, 2025

Related U.S. Application Data
(60) Provisional application No. 63/494,084, filed on Apr. 4, 2023.

(51) Int. Cl. H04L 5/00; H04L 27/26; H04W 72/0457; H04W 72/231; H04W 80/02

(52) U.S. Cl. CPC H04L 5/0051; H04L 27/2605; H04W 72/0457; H04W 72/231; H04W 80/02

(57) ABSTRACT

Described herein are systems, apparatuses, and methods to support a sounding reference signals (SRS) on eight ports using a comb of size four or a comb of size two. A net-work node may send a SRS-Resource information element that includes configuration details for a SRS for eight ports using a comb size that supports the SRS for the eight ports with a first number of comb offsets and a second number of comb offsets. The UE may determine whether to use the first number of comb offsets or the second number of comb offsets for SRS transmissions from the eight ports for the SRS-Resource.

### TECHNICAL FIELD

This application relates generally to wireless communication systems, including enhancements for supporting sounding reference signals on eight ports.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates SRS sequence mapping for a transmission, in accordance with some embodiments.

FIG. 2 illustrates a table that indicates a maximum number of cyclic shifts as a function of comb structure, in accordance with some embodiments.

FIG. 3 illustrates a table with one comb offset and multiple cyclic shifts to support eight port SRS with comb 2, in accordance with some embodiments.

FIG. 4 illustrates an SRS-Resource configuration that provides a comb offset and a cyclic shift for a comb 2 structure, in accordance with some embodiments.

FIG. 5 illustrates a table where two comb offsets and multiple cyclic shifts are used to support eight port SRS with a comb 2 structure, in accordance with some embodiments.

FIG. 6 illustrates a table with multiple comb offsets to support eight port SRS with comb 4 structure while maintaining a maximum number of cyclic shifts for comb 4 as shown in FIG. 2, in accordance with some embodiments.

FIG. 7 illustrates a table with multiple comb offsets to support eight port SRS with comb 4 structure while maintaining a maximum number of cyclic shifts for Comb 4 as shown in FIG. 2, in accordance with some embodiments.

FIG. 8 illustrates a configuration to implicitly determine the number of comb offsets based on a threshold associated with a comb offset value, in accordance with some embodiments.

FIG. 9 illustrates a configuration to implicitly determine the number of comb offsets based on a threshold associated with a cyclic shift value, in accordance with some embodiments.

FIG. 10 illustrates a flowchart of a method of a UE, according to embodiments herein.

FIG. 11 illustrates a flowchart of a method of a network node, according to embodiments herein.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Many wireless communication standards provide for the use of known signals (e.g., pilot or reference signals) for a variety of purposes, such as synchronization, measurements, equalization, control, etc. For example, in cellular wireless communications, sounding reference signals (SRS) may be used to estimate uplink channel quality. A wireless communication device or mobile device (i.e., UE) can transmit an SRS to a base station (e.g., eNB for LTE and gNB for NR). SRS gives information about the combined effect of multipath fading, scattering, Doppler and power loss of transmitted signal.

Using the SRS, the base station may estimate the channel quality and manage resources accordingly. For example, since the reference signals include data known to both the transmitter and the receiver, the receiver may use the reference signal to determine/identify various characteristics of the communication channel. This is commonly referred to as channel estimation, which is used in many high-end wireless communications such as LTE and 5G-NR communications. Known channel properties of a communication link in wireless communications are referred to as channel state information (CSI), which provides information indicative of the combined effects of, for example, scattering, fading, and power decay with distance. The CSI makes it possible to adapt transmissions to current channel conditions, which is useful for achieving reliable communications with high data rates in multi-antenna systems.

Oftentimes multi-antenna systems use precoding for improved communications. Precoding is an extension of beamforming to support multi-stream (or multi-layer) transmissions for multi-antenna wireless communications and is used to control the differences in signal properties between the respective signals transmitted from multiple antennas by modifying the signal transmitted from each antenna according to a precoding matrix. In one sense, precoding may be considered a process of cross coupling the signals before transmission (in closed loop operation) to equalize the demodulated performance of the layers. The precoding matrix is generally selected from a codebook that defines multiple precoding matrix candidates, wherein a precoding matrix candidate is typically selected according to a desired performance level based on any of a number of different factors such as current system configuration, communication environment, and/or feedback information from the receiver receiving the transmitted signal(s).

The feedback information may be used in selecting a precoding matrix candidate by defining the same codebook at both the transmitter and the receiver, and using the feedback information from the receiver as an indication of a preferred precoding matrix. Similarly, the feedback information may be used in selecting preferred ports for UE transmission.

An SRS design may include symbol location, repetition, comb, and cyclic shift. In NR Release-15 (Rel-15), a design for the SRS was outlined. In Rel-15, SRS can only be transmitted in the last 6 symbols of each slot. Further, the SRS can be repeated up to four symbols, and the SRS supports Comb 2/4.

NR Release-16 (Rel-16) provided enhancements for the SRS of Rel-15. In Rel-16, the SRS could be transmitted in any symbol in a slot. Further SRS supported repetition with 8 and 12 symbols.

NR Release-17 (Rel-17) provided further enhancements for SRS. For example, Rel-17 supported RB-level Partial Frequency Sounding (RPFS). For RPFS, Rel-17 supports start PRB location hopping. Rel-17 also supports SRS repetition with 10/14 symbols. Further, Rel-17 supported Comb 8. For Comb 8, Rel-17 supported a maximum of 6 cyclic shifts (CS).

In current NR specification, SRS only supports a maximum of 4 ports. It may be desirable to support more than four ports. For example, embodiments herein may support 8 transmit uplink which requires SRS with 8 ports. Therefore, embodiments may specify uplink (UL) demodulation reference signal (DMRS), SRS, SRS Resource Indicator (SRI), and transmit precoder matrix indicator (TPMI) (including codebook) enhancements to enable 8 Tx operation to support 4 and more layers per UE in UL targeting CPE/FA/vehicle/Industrial devices.

For an 8-port SRS resource in a SRS resource set with usage ‘codebook’ or ‘antennaSwitching’, when the 8 ports are mapped onto one or more OFDM symbols using legacy schemes (repetition, frequency hopping, partial sounding, or a combination thereof), embodiments may support the following. For comb 2, a wireless communication system may support 1 and 2 comb offsets. For comb 4, a wireless communication system may support 2 and 4 comb offset. For comb 8, a wireless communication system may support 4 comb offsets.

Some embodiments herein address the detailed design of using different number of comb offsets to support 8 port SRS. The number of comb offsets within possible designs include: comb 2 designs, comb 4 designs, and switching between different numbers of comb offsets.

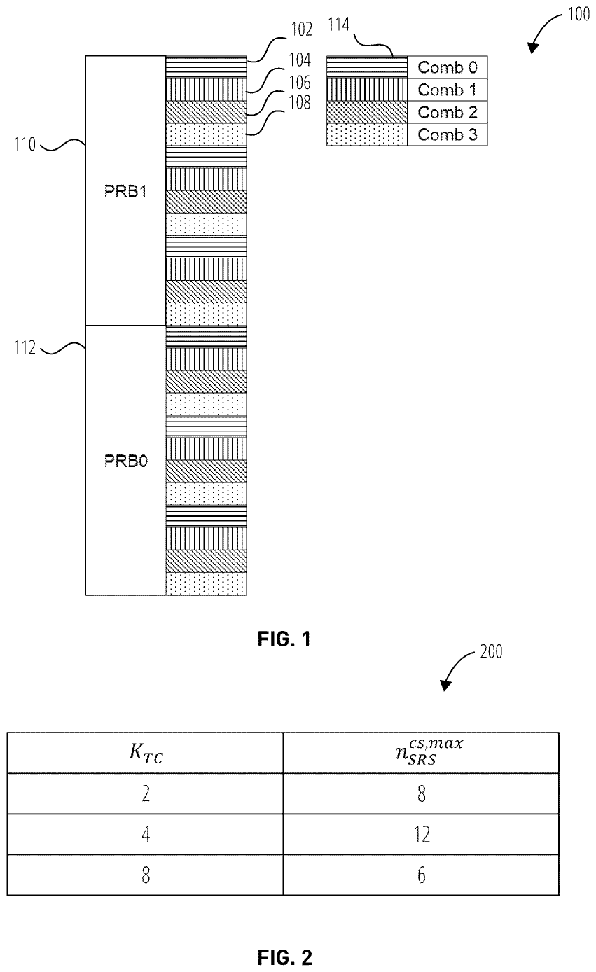

FIG. 1 illustrates SRS sequence mapping for a transmission 100. As shown, the transmission 100 includes a number of resource elements (REs) (e.g., first RE 102, second RE 104, third RE 106, and fourth RE 108). A RE is a frequency-time unit to which an SRS sequence is mapped. The transmission 100 further comprises multiple physical resource blocks (PRBs) (e.g., PRB1 110 and PRB2 112) comprising a plurality of contiguous REs. The SRS sequence may support a length of 6, 12, 18, 24, and any sequence greater than or equal to 36.

To support multiple ports and UEs, a comb structure for the transmission 100 may be used. An SRS sequence may be mapped to the frequency domain resources (e.g., first RE 102, second RE 104, third RE 106, and fourth RE 108) with the comb structure. NR currently supports comb 2, 4, and 8 for SRS. A comb 2 structure would be a case where an SRS is transmitted every other RE. FIG. 1 illustrates a comb 4 structure. As shown, in a comb 4 structure, the SRS sequences are transmitted every four resource elements. This provides four possible comb offsets 114. The comb offsets indicate the starting frequency of the comb structure for an SRS sequence. Similarly, an 8 comb structure would cause an SRS to transmit every eighth resource element. Transmitting according to a comb structure allows ports from the same UE or different UEs to transmit an SRS sequence without interfering with other SRS sequences. Comb N (N=2/4/8) subsamples the RE with a factor N, different comb offsets are orthogonal since they are non-overlapping in frequency

Another way for SRS transmissions to not interfere with other SRS transmissions is to apply multiple cyclic shift sequence on top of a same SRS sequence. The cyclic shift allows multiple transmission to be applied on the same frequency RE by overlapping orthogonal sequences. Thus, a wireless communication system may use comb structure and cyclic shift to increase its capacity. A length M cyclic shift sequence can have M orthogonal sequences. Thus, a length M cyclic shift can be used to create M orthogonal SRS ports using the same SRS comb offset and the same SRS sequence. The cyclic shift sequence length M may be a function of Comb size N.

FIG. 2 illustrates a table 200 that indicates a maximum number of cyclic shifts ( as a function of comb structure (AT) as designated by a NR standard. For each comb structure there is a defined number of cyclic shift in the NR standards. This determines how many SRS patterns can be used. For example, there is eight cyclic shifts for a comb 2 structure resulting in 16 (i.e., 2*8=16) ports or UEs that can be supported. As shown, in some embodiments, a Comb 2 has maximum 8 cyclic shifts, a Comb 4 has maximum 12 cyclic shifts, and a Comb 8 has maximum 6 cyclic shifts.

However, one of the issues with supporting more than four ports is how the cyclic shift are currently selected. The cyclic shift are chosen so that the cyclic sifts have equal distance between them. This requirement for equal distance may limit support for four or more ports. For example, support of four ports may be possible with comb 2 and 4 because four can be evenly divided into the maximum number of cyclic shifts (8 and 12). However, four ports could not be divided evenly into the six cyclic shifts of the comb 8. Similarly, eight ports could not be supported by either comb 4 or comb 8 with single comb offset.

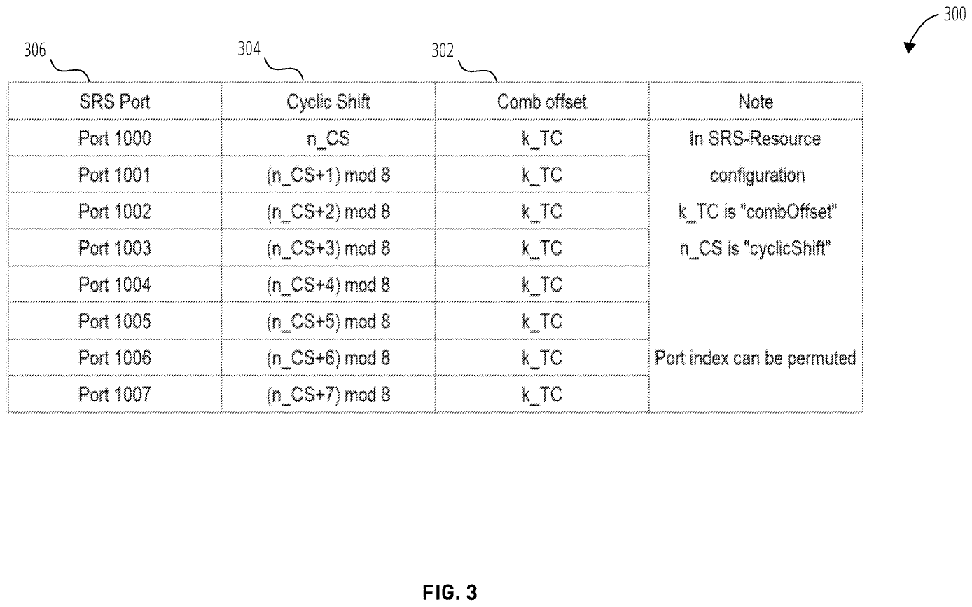

Some embodiments herein use multiple SRS comb offsets to support more than four ports. For example, FIGS. 3 and 5-7 illustrate how multiple SRS comb offsets may be used to support eight ports.

FIG. 3 illustrates a table 300 with one comb offset 302 and multiple cyclic shifts 304 to support 8 port SRS with comb 2, in accordance with some embodiments. The table 300 provides a mapping between the SRS ports 306, cyclic shifts 304, and the comb offset 302. The port index in the SRS ports column can be permuted based on the configuration (e.g., Port 7 may align with the first row).

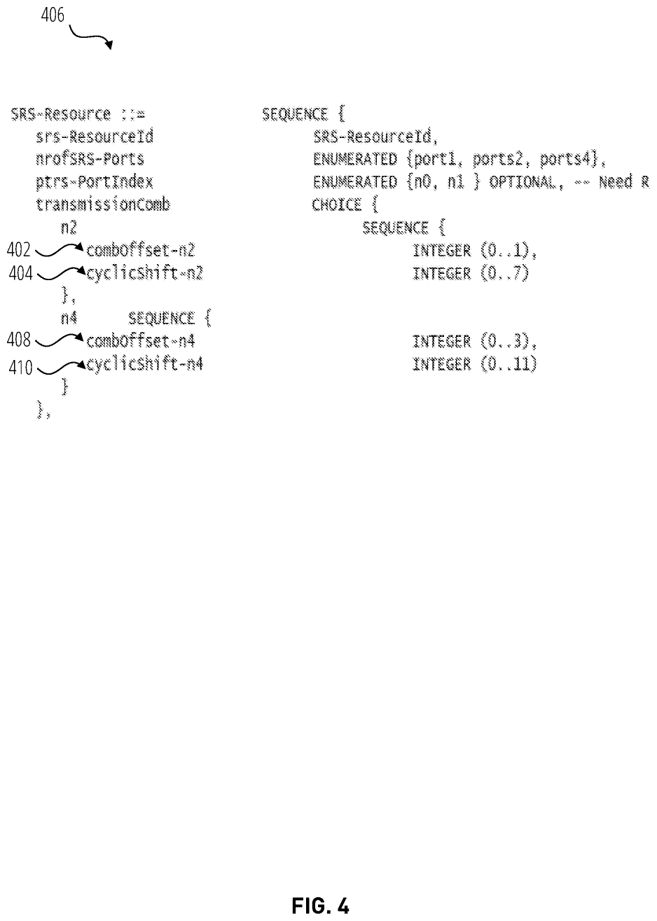

The illustrated embodiment, maintains the maximum number of cyclic shifts for comb 2 as shown in FIG. 2 (e.g., maximum cyclic shift is 8 for comb 2). The variable k TC in the comb offset column is a comb offset value from the SRS-Resource configuration. Similarly, the variable n_CS in the cyclic shifts column is used to define the cyclic shifts 304 and is from the SRS-Resource configuration. For example, FIG. 4 illustrates an SRS-Resource configuration 406 that provides a comb offset 402 and a cyclic shift 404 for a comb 2 structure.

Returning to FIG. 3, to support 8 port SRS the illustrated embodiment uses one comb offset 302. For the comb offset 302, the UE sends SRS on 8 ports. The SRS for each port is sent on a different cyclic shift. The cyclic shifts 304 for each port is defined in the cyclic shift column in accordance with some embodiments. The illustrate embodiment uses each of the cyclic shifts available for a comb 2 configuration.

As shown, the table 300 includes eight SRS ports 306 with equally spaced cyclic shifts 304 on one comb offset 302 of the comb 2 structure. Specifically, ports 1000, 1001, 1002, 1003, 1004, 1005, 1006, and 1007 may be orthogonally transmitted using a cyclic shift of n_CS, (n_CS+1) mod 8, (n_CS+2) mod 8, (n_CS+3) mod 8, (n_CS+4) mod 8, (n_CS+5) mod 8, (n_CS+6) mod 8, and (n_CS+7) mod 8 respectively. In this embodiment, the SRS for each of the two groups of four ports are evenly sampled across the cyclic shift sequence by a step size of one.

FIG. 4 illustrates an SRS-Resource configuration 406 that a network node may use to provide comb offset information and cyclic shift information to a UE. The illustrated SRS-Resource configuration 406 provides information for both a comb 2 and a comb 4. For example, the SRS-Resource configuration 406 includes a comb offset 402 and a cyclic shift 404 for a comb 2 and a comb offset 408 and a cyclic shift 410 for a comb 4.

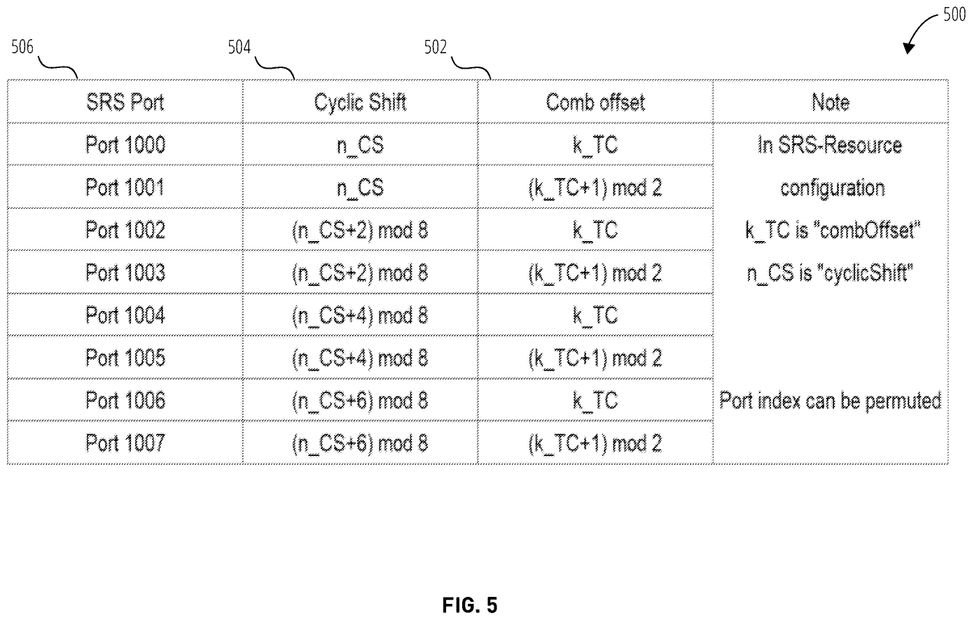

While the comb 2 structure is capable of supporting the eight SRS ports using one comb offset 302, it may be desirable to use two comb offsets. For example, certain channels may be frequency selective or have a large delay spread, and the ports using each of the cyclic shift sequences without a gap may result in interference. FIG. 5 illustrates an embodiment where both comb offsets of a comb 2 structure are used to support 8 port SRS.

FIG. 5 illustrates a table 500 where two comb offsets 502 and multiple cyclic shifts 504 are used to support 8 port SRS with a comb 2 structure, in accordance with some embodiments. The table 500 provides a mapping between the SRS ports 506, cyclic shifts 504, and comb offsets 502. The port index in the SRS ports column can be permuted based on the configuration (e.g., Port 7 may align with the first row).

The illustrated embodiment, maintains the maximum number of cyclic shifts for comb 2 as shown in FIG. 2 (e.g., maximum cyclic shift is 8 for comb 2). The variable k TC in the comb offset column is a comb offset value from the SRS-Resource configuration. Similarly, the variable n_CS in the cyclic shifts column is used to define the cyclic shifts 504 and is from the SRS-Resource configuration.

To support 8 port SRS the illustrated embodiment uses two comb offsets 502, and for every comb offset the UE sends SRS on 4 ports. In this embodiment, the SRS for each of the two groups of four ports are evenly sampled across the cyclic shift sequence by a step size of two.

For example, as shown, the table 500 includes eight SRS ports 506 with equally spaced cyclic shifts 504 using two comb offsets 502 of the comb 2 structure.

Specifically, ports 1000, 1002, 1004, and 1006 are located in comb offset k_TC. Further, ports 0, 2, 4, and 6 may be orthogonally transmitted using a cyclic shift of n_CS, (n_CS+2) mod 8, (n_CS+4) mod 8, and (n_CS+6) mod 8 respectively. The remaining four ports may be transmitted in a different comb offset to avoid interference. For instance, in the illustrated embodiment, ports 1001, 1003, 1005, and 1007 are located in comb offset (k_TC+1) mod 2. Further, ports 1001, 1003, 1005, and 1007 may be orthogonally transmitted using a cyclic shift of n_CS, (n_CS+2) mod 8, (n_CS+4) mod 8, and (n_CS+6) mod 8 respectively.

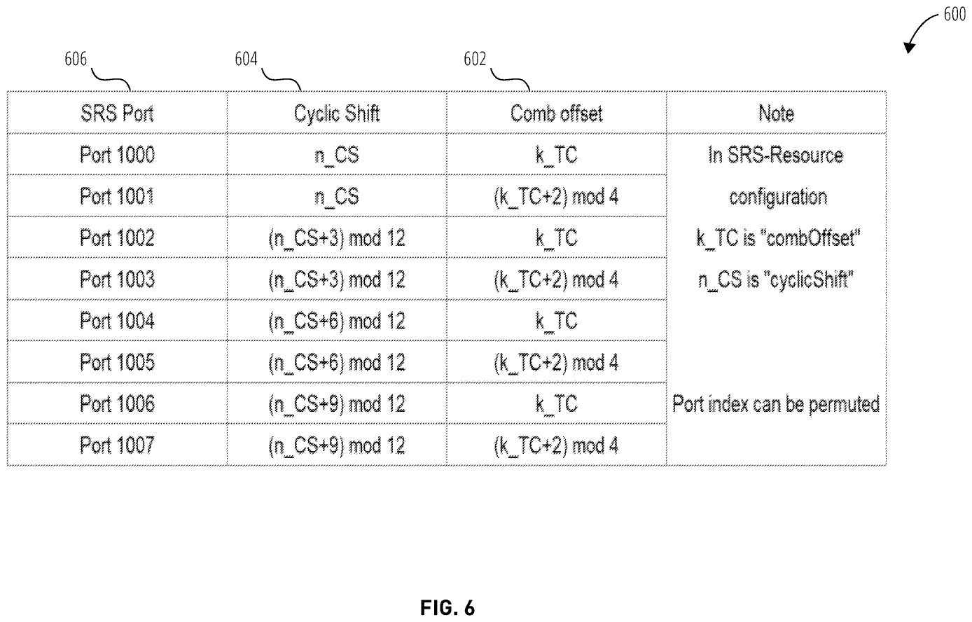

FIG. 6 illustrates a table 600 with multiple comb offsets 602 to support 8 port SRS with comb 4 structure while maintaining a maximum number of cyclic shifts for comb 4 as shown in FIG. 2 (e.g., maximum cyclic shift is 12 for comb 4). The variable K_TC in the comb offsets 602 column is a comb offset from the SRS-Resource configuration. Similarly, the variable n_CS in the cyclic shifts 604 column is the cyclic shift from the SRS-Resource configuration. For example, FIG. 4 illustrates an SRS-Resource configuration 406 that provides a comb offset 408 and a cyclic shift 410 for a comb 4 structure. The port index in the SRS ports 606 column can be permuted based on the configuration (e.g., Port 1007 may align with the first row).

To support 8 port SRS the illustrated embodiment uses two comb offsets 602, and for every comb offset the UE sends SRS on 4 ports. So while the maximum 12 cyclic shifts of comb 4 (from table 200) is not evenly dividable by the 8 ports, the embodiment splits the ports into two comb offsets 602 to make two groups of 4 ports which can evenly divide the 12 cyclic shifts.

As shown, the table 600 includes eight SRS ports 606 with equally spaced cyclic shifts 604 using two comb offsets 602 of the comb 4 structure. Specifically, ports 1000, 1002, 1004, and 1006 are located in comb offset k_TC. Further, ports 1000, 1002, 1004, and 1006 may be orthogonally transmitted using a cyclic shift of (n_CS+0) mod 12, (n_CS+3) mod 12, (n_CS+6) mod 12, and (n_CS+9) mod 12 respectively. The remaining four ports may be transmitted in a different comb offset to avoid interference. In some embodiments, the comb offset is selected so that the transmissions are evenly spaced along the available frequency resource elements. For instance, in the illustrated embodiment, ports 1001, 1003, 1005, and 1007 are located in comb offset (k_TC+2) mod 4. Further, ports 1001, 1003, 1005, and 1007 may be orthogonally transmitted using a cyclic shift of (n_CS+0) mod 12, (n_CS+3) mod 12, (n_CS+6) mod 12, and (n_CS+9) mod 12 respectively.

In this embodiment, the SRS for each of the two groups of four ports are evenly sampled across the cyclic shift sequence by a step size of three. Further, the two groups have an even distance between comb offsets (e.g., the groups are shifted by a factor of two).

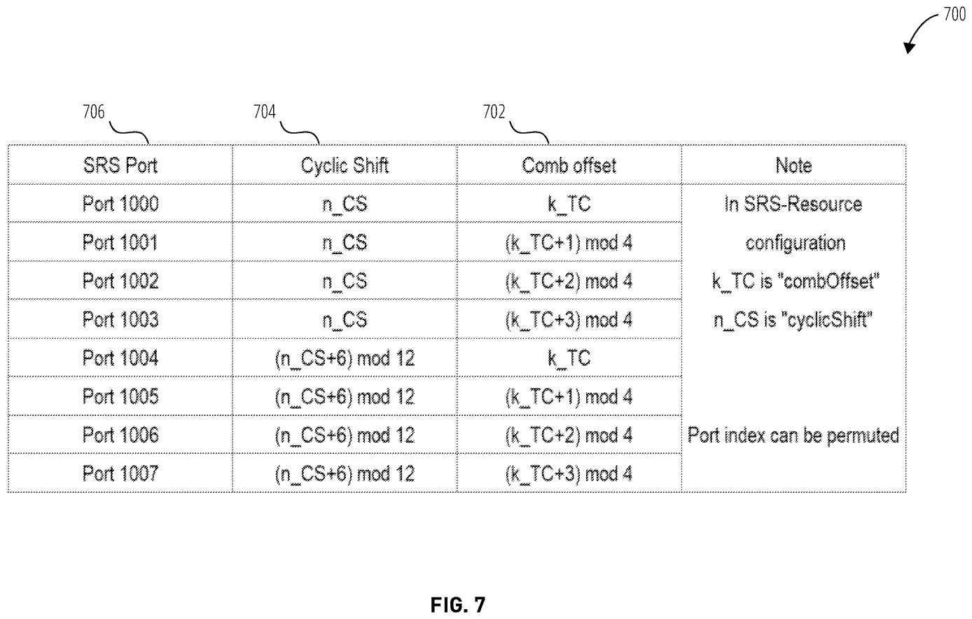

FIG. 7 illustrates a table 700 with multiple comb offsets 702 to support 8 port SRS with comb 4 structure while maintaining a maximum number of cyclic shifts for Comb 4 as shown in FIG. 2 (e.g., maximum cyclic shift is 12 for comb 4). The variable K_TC in the comb offsets 702 column is a comb offset from the SRS-Resource configuration. Similarly, the variable n_CS in the cyclic shifts 704 column is the cyclic shift from the SRS-Resource configuration. The port index in the SRS ports 706 column can be permuted based on the configuration (e.g., Port 1007 may align with the first row).

To support 8 port SRS the illustrated embodiment uses four comb offsets 702, and for each comb offset the UE sends SRS on 2 ports. So while the maximum 12 cyclic shifts of comb 4 (from table 200) is not evenly dividable by the 8 ports, the embodiment splits the ports into four comb offsets 702 to make four groups of 2 ports which can evenly divide the 12 cyclic shifts.

As shown, the table 700 includes eight SRS ports 706 with equally spaced cyclic shifts 704 using four comb offsets 702 of the comb 4 structure. Specifically, ports 1000 and 1004 are located in comb offset k_TC. Further, ports 1000 and 1004 are orthogonally transmitted using a cyclic shift of n_CS and (n_CS+6) mod 12, respectively. In the illustrated embodiment, ports 1001 and 1005 are located in comb offset (k_TC+1) mod 4. Further, ports 1001 and 1005 are orthogonally transmitted using a cyclic shift of n_CS and (n_CS+6) mod 12, respectively. In the illustrated embodiment, ports 1002 and 1006 are located in comb offset (k_TC+2) mod 4. Further, ports 1002 and 1006 are orthogonally transmitted using a cyclic shift of n_CS and (n_CS+6) mod 12, respectively. In the illustrated embodiment, ports 1003 and 1007 are located in comb offset (k_TC+3) mod 4. Further, ports 1003 and 1007 are orthogonally transmitted using a cyclic shift of n_CS and (n_CS+6) mod 12, respectively. In this embodiment, the SRS for each of the four groups of two ports are evenly sampled across the cyclic shift sequence by a step size of three.

In some embodiments, multiple comb designs for may be supported for 8 port SRS. For example, a wireless communication system may support both of the designs shown in FIG. 3 and FIG. 5 to support 8 port SRS with comb 2. Further, the wireless communication system may support both of the designs shown in FIG. 6 and FIG. 7 to support 8 port SRS with comb 4. Accordingly, in such embodiments, the UE determines which 8 port SRS configuration to use for SRS transmission.

To support 8 port SRS, when a particular comb size (e.g. Comb 2/4) can support 8 port SRS with different number of comb offsets, the following are the options to configure the actual number of comb offsets used for 8 port SRS. In some embodiments, the network node may explicitly configure which 8 port SRS configuration the UE is to use. For example, the network node may configure the number of comb offsets by Radio Resource Control (RRC) explicitly.

For instance, the network node may send an SRS-Resource configuration to a UE. Within the SRS-Resource configuration information element, the network node may define a comb offset value and a cyclic shift value as shown in FIG. 4. In addition, the SRS-Resource configuration information element may include an indication of which 8 port SRS design to use for comb 2 and comb 4. For instance, the SRS-Resource configuration information element may include the actual number of comb offsets to use for 8 port SRS for comb 2 and comb 4.

In some embodiments, the number of comb offsets for 8 port SRS may not be explicitly defined by the network node. In these embodiments, the UE may determine the number of comb offsets to use for 8 port SRS based on an implicit rule. For example, the UE may determine the number of comb offsets depending on the configured comb offset in the SRS-Resource configuration (i.e., combOffset). For example for comb 2, if the comb offset value is below a threshold, the UE may use the two comb offset design (e.g., table 500 of FIG. 5), else if the comb offset value is above the threshold the UE may use the one comb offset design (e.g., table 300 of FIG. 3). Similarly, in some embodiments, the UE may determine the number of comb offsets depending on the configured cyclic shift (i.e., cyclicShift).

It may be desirable to change which 8 port SRS design is used based on the dynamic profile of the wireless communication system. In some embodiments, to support 8 port SRS, when a particular comb size (e.g. Comb 2/4) can support 8 port SRS with different number of comb offsets, the network node may explicitly configure the number of comb offsets used for 8 port SRS. For example, medium access control (MAC) control element (CE) or downlink control indicator (DCI) may be used to change the comb offsets. The MAC CE can be used to update the number of comb offsets. The DCI can be used to indicate the number of comb offsets. For example, the DCI can be used to indicate the number of comb offsets for aperiodic SRS resources.

A network node may dynamically change the number of comb offsets based on a channel profile. For example, if a channel delay profile is large the network node may configure a larger number of comb offsets. If a channel delay profile is small, the network node may use a smaller number of comb offsets.

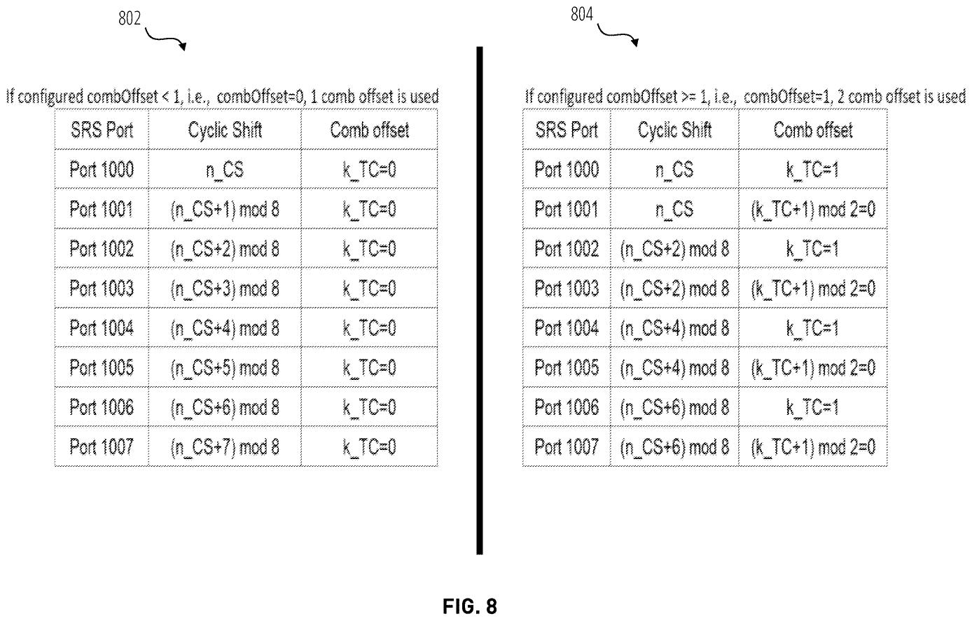

FIG. 8 illustrates one possible embodiment to implicitly determine the number of comb offsets based on a threshold associated with a comb offset value. The comb offset value may be set in the SRS-Resource configuration using the combOffset field. The threshold may be used to implicitly switch between using a different number of comb offsets for 8 port SRS. For example, the threshold may be used to determine if a first comb design 802 should be used or if a second comb design 804 should be used.

To support 8 port SRS, when a particular comb size (e.g. Comb 2/4) may support 8 port SRS with different number of comb offsets, if implicit configuration of number of comb offsets is used for 8 port SRS, the UE may determine the number of comb offsets based on a threshold. If combOffset is used, the threshold may be defined for the combOffset. The threshold may be denoted as X. When configured as combOffset<X, a first number of comb offsets may be used. When configured as combOffset>=X, the other number of comb offsets may be used. When comb 2 is used, and the system supports both 1 comb offset and 2 comb offsets for 8 port SRS, X may be set to one.

In the illustrated embodiment, the threshold is set to one. If the comb offset value is less than the threshold (e.g., combOffset=0), the first comb design 802 is used. The first comb design 802 uses one comb offset and eight cyclic shifts as discussed with reference to FIG. 3. If the comb offset value is greater than or equal to the threshold (e.g., combOffset=1), the second comb design 802 is used. The second comb design 802 uses two comb offsets and four cyclic shifts as discussed with reference to FIG. 5.

In the illustrated embodiment, the comb size is two. However, a similar threshold may be used to support a comb size of four. For example, the threshold may be set to two. If the comb offset value is less than two, the comb design described with reference to FIG. 6 may be used. If the comb offset value is greater than or equal to two, the comb design described with reference to FIG. 7 may be used.

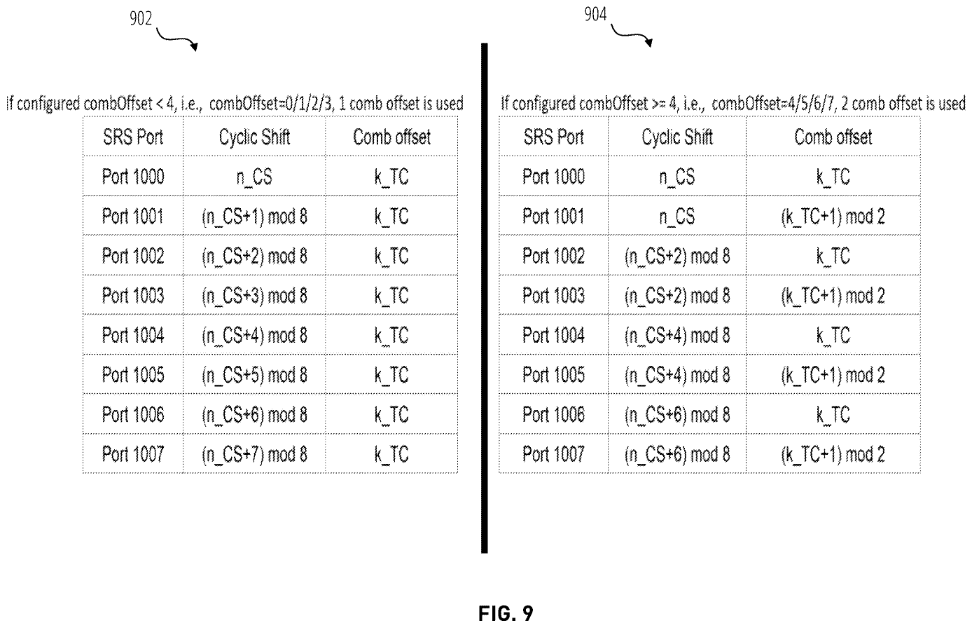

FIG. 9 illustrates one possible embodiment to implicitly determine the number of comb offsets based on a threshold associated with a cyclic shift value. The cyclic shift value may be set in the SRS-Resource configuration using the cyclicShift field. The threshold may be used to implicitly switch between using a different number of comb offsets for 8 port SRS. For example, the threshold may be used to determine if a first comb design 902 should be used or if a second comb design 904 should be used.

To support 8 port SRS, when a particular comb size (e.g. Comb 2/4) may support 8 port SRS with different number of comb offsets, if implicit configuration of number of comb offsets is used for 8 port SRS, the UE may determine the number of comb offsets based on a threshold. If cyclicShift is used, the threshold may be defined for the cyclicShift. The threshold may be denoted as X. When configured as cyclicShift<X, a first number of comb offsets may be used. When configured as cyclicShift>=X, the other number of comb offsets may be used. When comb 2 is used, and the system supports both 1 comb offset and 2 comb offsets for 8 port SRS, X may be set to four.

In the illustrated embodiment, the threshold is set to four for comb 2. If the cyclic shift value is less than the threshold (e.g., cyclicShift=0, 1, 2, or 3), the first comb design 902 is used. The first comb design 902 uses one comb offset and eight cyclic shifts as discussed with reference to FIG. 3. If the cyclic shift value is greater than or equal to the threshold (e.g., cyclicShift=4, 5, 6, or 7), the second comb design 902 is used. The second comb design 902 uses two comb offsets and four cyclic shifts as discussed with reference to FIG. 5.

In the illustrated embodiment, the comb size is two. However, a similar threshold may be used to support a comb size of four. For example, the threshold may be set to six. If the cyclic shift value is less than six, the comb design described with reference to FIG. 6 may be used. If the cyclic shift value is greater than or equal to six, the comb design described with reference to FIG. 7 may be used.

In some embodiments, restrictions can be configured when a system supports 8 port SRS with multiple number of comb offsets. The restrictions may simplify implementation and make the number of combo offsets used for SRS resources more uniform. In some embodiments, all of the SRS-Resource in the same SRS-ResourceSet may have the same number of comb offsets to support 8 port. For instance, if a first SRS-Resource is configured to use one comb offset, all the other SRS-Resources in the same SRS-ResourceSet will use one comb offset. In some embodiments, all the SRS-Resource in the same active uplink (UL) bandwidth part (BWP) may have the same number of comb offsets to support 8 port. In such embodiments, even if SRS-resources are in different sets, if they are on the same active UL BWP the SRS-resources will use a same number of comb offsets to support 8 port SRS. In some embodiments, all the SRS-Resources in the same serving cell may have the same number of comb offsets to support 8 port.

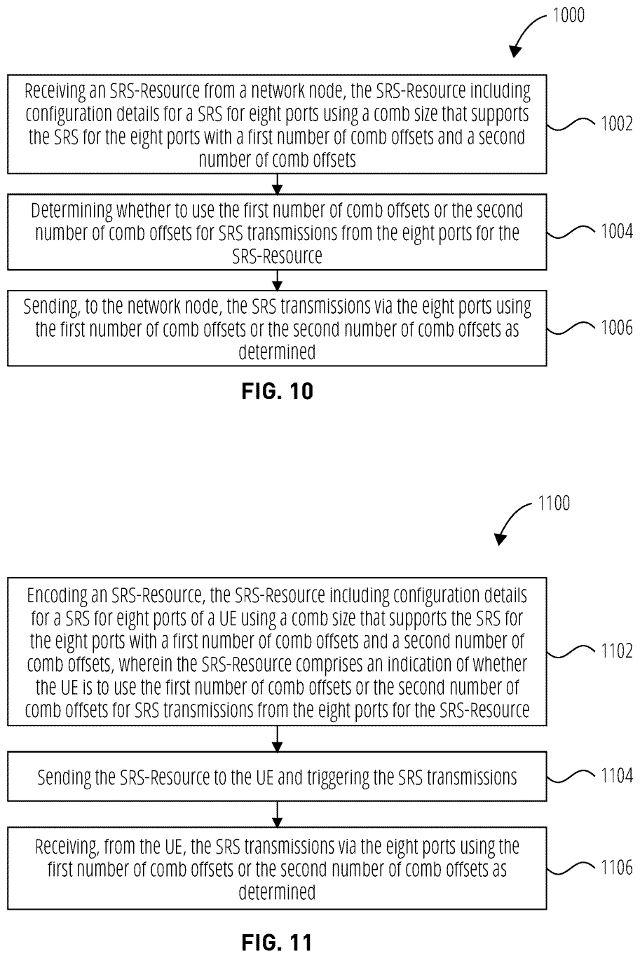

FIG. 10 illustrates a flowchart of a method 1000 of a UE, according to embodiments herein. The method 1000 includes receiving 1002 an SRS-Resource from a network node, the SRS-Resource including configuration details for a SRS for eight ports using a comb size that supports the SRS for the eight ports with a first number of comb offsets and a second number of comb offsets.

The method 1000 further includes determining 1004 whether to use the first number of comb offsets or the second number of comb offsets for SRS transmissions from the eight ports for the SRS-Resource.

The method 1000 further includes sending 1006, to the network node, the SRS transmissions via the eight ports using the first number of comb offsets or the second number of comb offsets as determined.

In some embodiments of the method 1000, the SRS-Resource comprises a field that indicates a number of comb offsets that the UE is to use for SRS for the comb size, and determining whether to use the first number of comb offsets or the second number of comb offsets is based on the field. Some such embodiments further comprise receiving a MAC-CE or a DCI comprising an update to the number of comb offsets.

In some embodiments of the method 1000, the SRS-Resource comprises a comb offset value and a cyclic shift value, wherein determining whether to use the first number of comb offsets or the second number of comb offsets comprises: comparing the comb offset value or the cyclic shift value to a threshold, wherein when the comb offset value or the cyclic shift value is less than the threshold the second number of comb offsets is used, and when the comb offset value or the cyclic shift value is greater than or equal to the threshold the second number of comb offsets is used.

In some embodiments of the method 1000, for comb size two, the first number of comb offsets is one comb offset and the second number of comb offsets is two comb offsets, wherein, for the one comb offset, eight cyclic shifts are used to send the SRS transmissions, each cyclic shift corresponding to one of the eight ports and wherein, for the two comb offsets, four cyclic shifts are used per comb offset to send the SRS transmissions, wherein the eight ports are evenly divided between the two comb offsets.

In some embodiments of the method 1000, for comb size four, the first number of comb offsets is two comb offsets and the second number of comb offsets is four comb offsets, wherein, for the two comb offsets, four cyclic shifts are used per comb offset to send the SRS transmissions, wherein the eight ports are evenly divided between the two comb offsets and wherein, for the four comb offsets, two cyclic shifts are used per comb offset to send the SRS transmissions, wherein the eight ports are evenly divided between the four comb offsets.

In some embodiments of the method 1000, all SRS resources in a same SRS-Resource set use the same number of comb offsets to support the SRS for the eight ports.

In some embodiments of the method 1000, all SRS resources in a same active UL BWP use the same number of comb offsets to support the SRS for the eight ports.

In some embodiments of the method 1000, all SRS resources in a same serving cell shall use the same number of comb offsets to support the SRS for the eight ports.

Embodiments contemplated herein include an apparatus comprising means to perform one or more elements of the method 1000. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of the method 1000. This non-transitory computer-readable media may be, for example, a memory of a UE (such as a memory 1306 of a wireless device 1302that is a UE, as described herein).

Embodiments contemplated herein include an apparatus comprising logic, modules, or circuitry to perform one or more elements of the method 1000. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of the method 1000. This apparatus may be, for example, an apparatus of a UE (such as a wireless device 1302 that is a UE, as described herein).

Embodiments contemplated herein include a signal as described in or related to one or more elements of the method 1000.

Embodiments contemplated herein include a computer program or computer program product comprising instructions, wherein execution of the program by a processor is to cause the processor to carry out one or more elements of the method 1000. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

FIG. 11 illustrates a flowchart of a method 1100 of a network node, according to embodiments herein. The method 1100 includes encoding 1102 an SRS-Resource, the SRS-Resource including configuration details for a SRS for eight ports of a UE using a comb size that supports the SRS for the eight ports with a first number of comb offsets and a second number of comb offsets, and the SRS-Resource comprises an indication of whether the UE is to use the first number of comb offsets or the second number of comb offsets for SRS transmissions from the eight ports for the SRS-Resource.

The method 1100 further includes sending 1104 the SRS-Resource to the UE and triggering the SRS transmissions.

The method 1100 further includes receiving 1106, from the UE, the SRS transmissions via the eight ports using the first number of comb offsets or the second number of comb offsets as determined.

In some embodiments of the method 1100, the SRS-Resource comprises a field that explicitly indicates a number of comb offsets that the UE is to use for SRS for the comb size. Some such embodiments further comprise sending a MAC-CE or a DCI comprising an update to the number of comb offsets.

In some embodiments of the method 1100, the SRS-Resource comprises a comb offset value and a cyclic shift value, wherein the indication of whether the UE is to use the first number of comb offsets or the second number of comb offsets is based on a comparison of the comb offset value or the cyclic shift value to a threshold, when the comb offset value or the cyclic shift value is less than the threshold the first number of comb offsets is used, and when the comb offset value or the cyclic shift value is greater than or equal to the threshold the second number of comb offsets is used.

In some embodiments of the method 1100, for comb size two, the first number of comb offsets is one comb offset and the second number of comb offsets is two comb offsets wherein, for the one comb offset, eight cyclic shifts are used for the SRS transmissions, each cyclic shift corresponding to one of the eight ports, and wherein, for the two comb offsets, four cyclic shifts are used per comb offset for the SRS transmissions, wherein the eight ports are evenly divided between the two comb offsets.

In some embodiments of the method 1100, for comb size four, the first number of comb offsets is two comb offsets and the second number of comb offsets is four comb offsets wherein, for the two comb offsets, four cyclic shifts are used per comb offset for the SRS transmissions, wherein the eight ports are evenly divided between the two comb offsets and wherein, for the four comb offsets, two cyclic shifts are used per comb offset for the SRS transmissions, wherein the eight ports are evenly divided between the four comb offsets.

In some embodiments of the method 1100, all SRS resources in a same SRS-Resource set use the same number of comb offsets to support the SRS for the eight ports.

In some embodiments of the method 1100, all SRS resources in a same active UL BWP use the same number of comb offsets to support the SRS for the eight ports.

In some embodiments of the method 1100, all SRS resources in a same serving cell shall use the same number of comb offsets to support the SRS for the eight ports.

Embodiments contemplated herein include an apparatus comprising means to perform one or more elements of the method 1100. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the method 1100. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a base station (such as a network device 1318 that is a base station, as described herein).

Embodiments contemplated herein include a signal as described in or related to one or more elements of the method 1100.

Embodiments contemplated herein include a computer program or computer program product comprising instructions, wherein execution of the program by a processing element is to cause the processing element to carry out one or more elements of the method 1100. The processor may be a processor of a base station (such as a processor(s) 1320 of a network device 1318 that is a base station, as described herein).

These instructions may be, for example, located in the processor and/or on a memory of the base station (such as a memory 1122 of a network device 1118 that is a base station, as described herein).

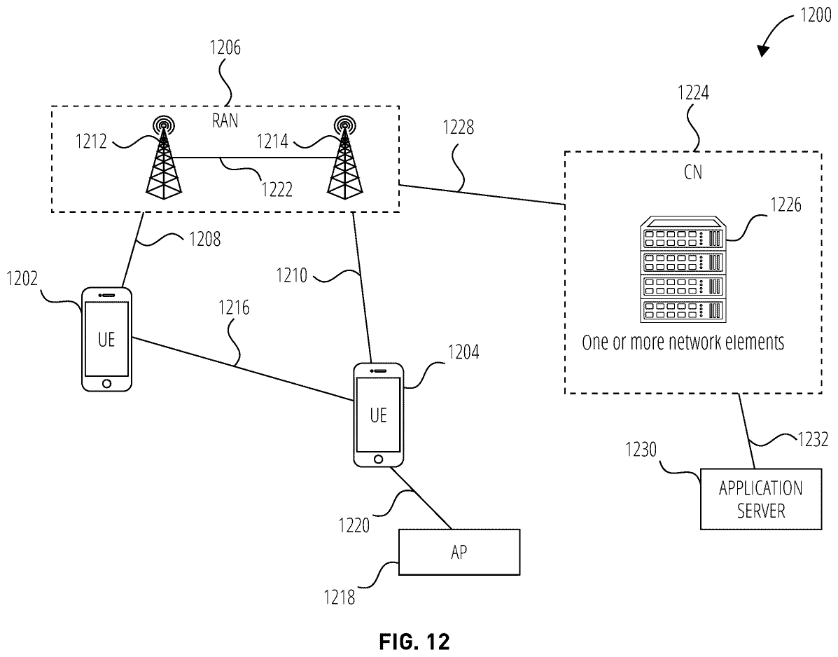

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations (such as base station 1212 and base station 1214) that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

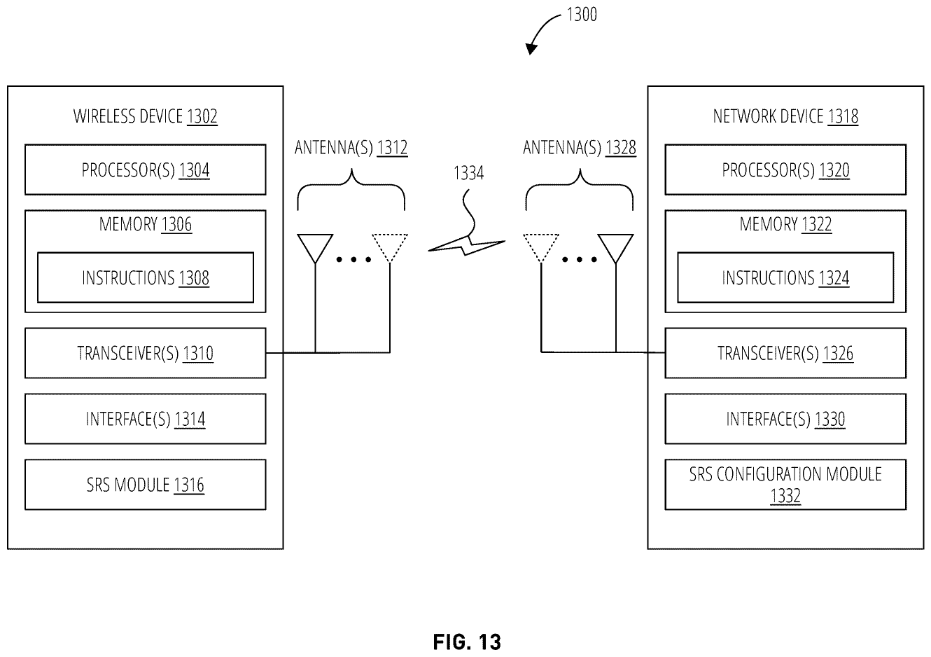

FIG. 13 illustrates a system 1300 for performing signaling 1334 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter circuitry and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include an SRS module 1316. The SRS module 1316 may be implemented via hardware, software, or combinations thereof. For example, the SRS module 1316 may be implemented as a processor, circuit, and/or instructions 1308 stored in the memory 1306 and executed by the processor(s) 1304. In some examples, the SRS module 1316 may be integrated within the processor(s) 1304 and/or the transceiver(s) 1310. For example, the SRS module 1316 may be implemented by a combination of software components (e.g., executed by a DSP or a general processor) and hardware components (e.g., logic gates and circuitry) within the processor(s) 1304 or the transceiver(s) 1310.

The SRS module 1316 may be used for various aspects of the present disclosure, for example, aspects of FIGS. 2-10. The SRS module 1316 is configured to configure the wireless device 1302 to send SRS. The configuration includes determining the number of comb offsets to use when transmitting the SRS.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter circuitry and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1318 may include an SRS configuration module 1332. The SRS configuration module 1332 may be implemented via hardware, software, or combinations thereof. For example, the SRS configuration module 1332 may be implemented as a processor, circuit, and/or instructions 1324 stored in the memory 1322 and executed by the processor(s) 1320. In some examples, the SRS configuration module 1332 may be integrated within the processor(s) 1320 and/or the transceiver(s) 1326. For example, the SRS configuration module 1332 may be implemented by a combination of software components (e.g., executed by a DSP or a general processor) and hardware components (e.g., logic gates and circuitry) within the processor(s) 1320 or the transceiver(s) 1326.

The SRS configuration module 1332 may be used for various aspects of the present disclosure, for example, aspects of FIGS. 2-9, and 11. The SRS configuration module 1332 is configured to encode and send configuration details for a SRS.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
receiving a sounding reference signals resource (SRS-Resource) from a network node, the SRS-Resource including configuration details for a SRS for eight ports using a comb size that supports the SRS for the eight ports with a first number of comb offsets and a second number of comb offsets,
determining whether to use the first number of comb offsets or the second number of comb offsets for SRS transmissions from the eight ports for the SRS-Resource; and
sending, to the network node, the SRS transmissions via the eight ports using the first number of comb offsets or the second number of comb offsets as determined.

2. The method of claim 1, wherein the SRS-Resource comprises a field that indicates a number of comb offsets that the UE is to use for SRS for the comb size, and
wherein determining whether to use the first number of comb offsets or the second number of comb offsets is based on the field.

3. The method of claim 2, further comprising receiving a medium access control (MAC) control element (CE) or a downlink control indicator (DCI) comprising an update to a current number of comb offsets.

4. The method of claim 1, wherein the SRS-Resource comprises a comb offset value and a cyclic shift value,
wherein determining whether to use the first number of comb offsets or the second number of comb offsets comprises:
comparing the comb offset value or the cyclic shift value to a threshold,
wherein when the comb offset value or the cyclic shift value is less than the threshold the first number of comb offsets is used, and when the comb offset value or the cyclic shift value is greater than or equal to the threshold the second number of comb offsets is used.

5. The method of claim 1, wherein, for comb size two, the first number of comb offsets is one comb offset and the second number of comb offsets is two comb offsets,
wherein, for the one comb offset, eight cyclic shifts are used to send the SRS transmissions, each cyclic shift corresponding to one of the eight ports; and
wherein, for the two comb offsets, four cyclic shifts are used per comb offset to send the SRS transmissions, wherein the eight ports are evenly divided between the two comb offsets.

6. The method of claim 1, wherein, for comb size four, the first number of comb offsets is two comb offsets and the second number of comb offsets is four comb offsets,
wherein, for the two comb offsets, four cyclic shifts are used per comb offset to send the SRS transmissions, wherein the eight ports are evenly divided between the two comb offsets; and
wherein, for the four comb offsets, two cyclic shifts are used per comb offset to send the SRS transmissions, wherein the eight ports are evenly divided between the four comb offsets.

7. The method of claim 1, wherein all SRS resources in a same SRS-Resource set use the same number of comb offsets to support the SRS for the eight ports.

8. The method of claim 1, wherein all SRS resources in a same active uplink (UL) bandwidth part (BWP) use the same number of comb offsets to support the SRS for the eight ports.

9. The method of claim 1, wherein all SRS resources in a same serving cell shall use the same number of comb offsets to support the SRS for the eight ports.

10. An apparatus of a user equipment (UE) comprising:
a processor; and
a memory storing instructions that, when executed by the processor, configure the UE to:
receive a sounding reference signals resource (SRS-Resource) from a network node, the SRS-Resource including configuration details for a SRS for eight ports using a comb size that supports the SRS for the eight ports with a first number of comb offsets and a second number of comb offsets,
determine whether to use the first number of comb offsets or the second number of comb offsets for SRS transmissions from the eight ports for the SRS-Resource; and
send, to the network node, the SRS transmissions via the eight ports using the first number of comb offsets or the second number of comb offsets as determined.

11. The apparatus of claim 10, wherein the SRS-Resource comprises a field that indicates a number of comb offsets that the UE is to use for SRS for the comb size, and
wherein determining whether to use the first number of comb offsets or the second number of comb offsets is based on the field.

12. The apparatus of claim 11, wherein the instructions further configure the UE to receive a medium access control (MAC) control element (CE) or a downlink control indicator (DCI) comprising an update to a current number of comb offsets.

13. The apparatus of claim 10, wherein the SRS-Resource comprises a comb offset value and a cyclic shift value,
wherein determining whether to use the first number of comb offsets or the second number of comb offsets comprises comparing the comb offset value or the cyclic shift value to a threshold,
wherein when the comb offset value or the cyclic shift value is less than the threshold the first number of comb offsets is used, and when the comb offset value or the cyclic shift value is greater than or equal to the threshold the second number of comb offsets is used.

14. The apparatus of claim 10, wherein, for comb size two, the first number of comb offsets is one comb offset and the second number of comb offsets is two comb offsets,
wherein, for the one comb offset, eight cyclic shifts are used to send the SRS transmissions, each cyclic shift corresponding to one of the eight ports; and
wherein, for the two comb offsets, four cyclic shifts are used per comb offset to send the SRS transmissions, wherein the eight ports are evenly divided between the two comb offsets.

15. The apparatus of claim 10, wherein, for comb size four, the first number of comb offsets is two comb offsets and the second number of comb offsets is four comb offsets,
wherein, for the two comb offsets, four cyclic shifts are used per comb offset to send the SRS transmissions, wherein the eight ports are evenly divided between the two comb offsets; and
wherein, for the four comb offsets, two cyclic shifts are used per comb offset to send the SRS transmissions, wherein the eight ports are evenly divided between the four comb offsets.

16. The apparatus of claim 10, wherein all SRS resources in a same SRS-Resource set use the same number of comb offsets to support the SRS for the eight ports.

17. The apparatus of claim 10, wherein all SRS resources in a same active uplink (UL) bandwidth part (BWP) use the same number of comb offsets to support the SRS for the eight ports.

18. The apparatus of claim 10, wherein all SRS resources in a same serving cell shall use the same number of comb offsets to support the SRS for the eight ports.

19. A method for a network node, the method comprising:
encoding a sounding reference signals resource (SRS-Resource), the SRS-Resource including configuration details for a SRS for eight ports of a user equipment (UE) using a comb size that supports the SRS for the eight ports with a first number of comb offsets and a second number of comb offsets,
wherein the SRS-Resource comprises an indication of whether the UE is to use the first number of comb offsets or the second number of comb offsets for SRS transmissions from the eight ports for the SRS-Resource;
sending the SRS-Resource to the UE and triggering the SRS transmissions; and
receiving, from the UE, the SRS transmissions via the eight ports using the first number of comb offsets or the second number of comb offsets as determined.

20. The method of claim 19, wherein the SRS-Resource comprises a field that explicitly indicates a number of comb offsets that the UE is to use for SRS for the comb size.

21-36. (canceled)
